(19) United States
(12) Patent Application Publication
(10) Pub. No.: US 2012/0174151 A1
(43) Pub. Date: Jul. 5, 2012

(54) PROVIDING ADVERTISING CONTENT TO A USER

(76) Inventors: Jennifer Reynolds, Johns Creek, GA (US); Charles Dasher, Lawrenceville, GA (US); Dheeraj Ravula, Roswell, GA (US); Paul Canter, Gainesville, GA (US); Bob Toxen, Duluth, GA (US)

(21) Appl. No.: 12/981,799

(22) Filed: Dec. 30, 2010

(51) Int. Cl. G06Q 30/00; H04N 7/025

(52) U.S. Cl. 725/34; 705/14.53

(57) ABSTRACT

A user equipment (UE) includes a location sensing mechanism, a memory for storing identity of a plurality of location co-ordinates visited by a user of the user equipment, a processor for determining preferences corresponding to the user based on the stored locations and a transceiver for communicating the preferences.

### BACKGROUND

The invention relates to technological mechanisms for providing advertising content to a user, and more particularly to technological mechanisms for providing advertising content to a user wherein the advertising content is known to be of relevance to the user.

Providers of advertising content have long used traditional communication media (e.g., print media such as newspapers and magazines, and electronic media such as radio and television commercials) to reach potential customers in the hopes of influencing the recipients of the advertising content to act in a certain manner (e.g., to purchase a particular product). A traditional way of increasing the effectiveness of any particular advertising campaign is simply to present the advertising content to as many people as possible. The effectiveness of this strategy relies on the advertising content being relevant to only a fraction of the population that receives it. Assuming that the fraction remains constant, increasing the absolute number of people who are swayed by the advertising content is achievable by increasing the size of the recipient population.

The inventors of the subject matter described herein have recognized that traditional techniques for providing advertising content are at best inefficient. Furthermore, as technological advances create more and more media outlets for users to select from (e.g., hundreds of possible cable television channels, many thousands of potential websites for Internet users to select from), it is increasingly impractical to reach a wider audience.

The inventors of the subject matter described herein have accordingly recognized that another way of increasing the effectiveness of advertising content is to present it in an intelligent manner that targets the audience for whom the content has some particular relevance.

For example, it is increasingly becoming common to have communication devices being equipped with location sensing mechanisms such as GPS, etc. These devices provide navigation functionality and enable the user (or consumer) to locate information on nearby places of interest to the user such as parks, shopping centers, specific stores, restaurants, etc.

While location information on places visited by the user may be collected, there is no mechanisms that allow manufacturers to capitalize on this location information, particularly with respect to influencing which products or services are purchased.

It is therefore desirable to provide technology that utilizes information based on places visited by a consumer to facilitate a manufacturer's ability to influence a consumer's selection of goods or services.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with one aspect of the present invention, the foregoing and other objects are achieved in methods, systems, and apparatuses for providing advertising content to a user. A user equipment (UE) according to exemplary embodiment includes a location sensing mechanism, a memory for storing location co-ordinates of a plurality of locations visited by a user of the user equipment, a processor for determining preferences corresponding to the user based on the stored co-ordinates and a transceiver for communicating the preferences.

In other embodiments, an advertisement presentation method is disclosed. The method includes storing location co-ordinates of a plurality of locations visited by a user of a user equipment, determining preferences corresponding to the user based on the stored co-ordinates, communicating the preferences to an advertisement control device and presenting advertisements received from the device to the user based on the communicated preferences.

In additional embodiments, a computer program is disclosed. The computer program includes computer readable program modules which when run on a user equipment causes the user equipment to store location co-ordinates of a plurality of locations visited by a user of a user equipment, determine preferences corresponding to the user based on the stored co-ordinates, communicate the preferences to an advertisement control device and present advertisements received from the device to the user based on the communicated preferences.

### BRIEF DESCRIPTION OF THE DRAWINGS

The objects and advantages of the invention will be understood by reading the following detailed description in conjunction with the drawings in which:

FIG. 1 illustrates a geographic area within which location co-ordinates visited by a user of user equipment are stored according to exemplary embodiments.

FIG. 2 illustrates an advertisement presentation method in accordance with exemplary embodiments.

FIG. 3 illustrates a user profile creation method in accordance with exemplary embodiments.

FIG. 4 illustrates a system in accordance with exemplary embodiments.

FIG. 5 illustrates a user equipment in accordance with exemplary embodiments.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits and/or one or more programmed processors). Moreover, the invention can additionally be considered to be embodied entirely within any form of computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

The terms “user device” and “user equipment” have been used interchangeably in the following description. Similarly, the terms “user preferences” and “user profiles” have been used interchangeably.

The inventors of the subject matter described herein have recognized that information on locations visited, or frequented, by a consumer can be utilized more intelligently to assist or influence the consumer's selection of goods and services.

In order to facilitate implementation of embodiments as described in further detail below, a number of locations may be equipped with means for issuing “detection” signals to mobile communication devices that are equipped with location sensing means such as GPS, etc. The locations may correspond to places providing consumer goods and/or services. In response to these signals, the mobile devices may register the present location co-ordinates of the devices. The location co-ordinates may be in the form degrees, minutes and seconds for both latitude and longitude for example. The co-ordinates could also include altitude or elevation in some embodiments. The locations that issue these signals may subscribe to an advertising service for example. The locations can thus also receive compensation by advertisers for providing the signals. The detection signals may be issued at a pre-determined frequency or as a result of the occurrence of a particular event such as an opening of the door to the business establishment for example.

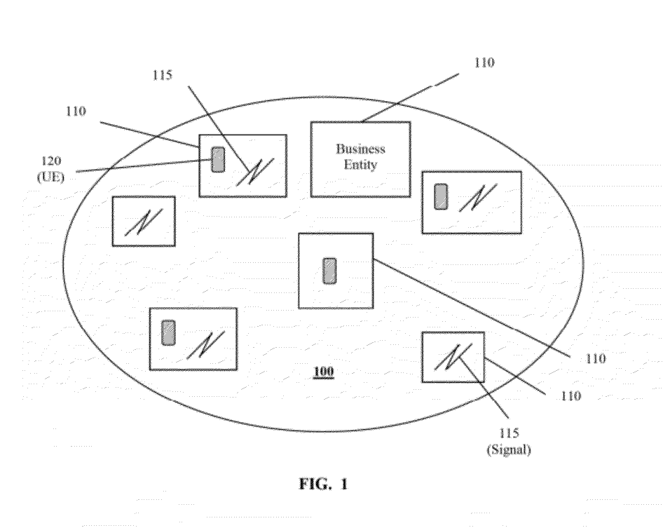

As illustrated in FIG. 1, area 100 may correspond to a geographic area such as a city, county, state, country, etc. Within geographic area 100, there may be a plurality of locations representing various business establishments 110 providing goods and/or services. Examples of business establishments may include automobile dealerships, auto repair shops, restaurants, electronic goods stores, bookstores, grocery stores, movie theatres, etc. Some, but not necessarily all, of the business establishments 110 may issue registration signals 115. Mobile communication devices 120 (may also be referred to as a mobile terminal or a user device or a user equipment), when they enter, or are within a vicinity of, a business establishment 100 providing the registration signal 115 may store the location of the business establishment in response to the registration signal. The location can be determined by location sensing mechanisms found in some mobile devices. A global positioning system (GPS) is one, but not the only, such example of a location sensing mechanism.

The detection signal or prompt 115 may also include the location and/or identification of the establishment (issuing the signal) in some embodiments. Identification of a particular establishment may be “ABC Bookstore” for example. Signal 115 may also, in other embodiments, provide an identification of the type of business establishment. The type of business identification may be “Bookstore” for example.

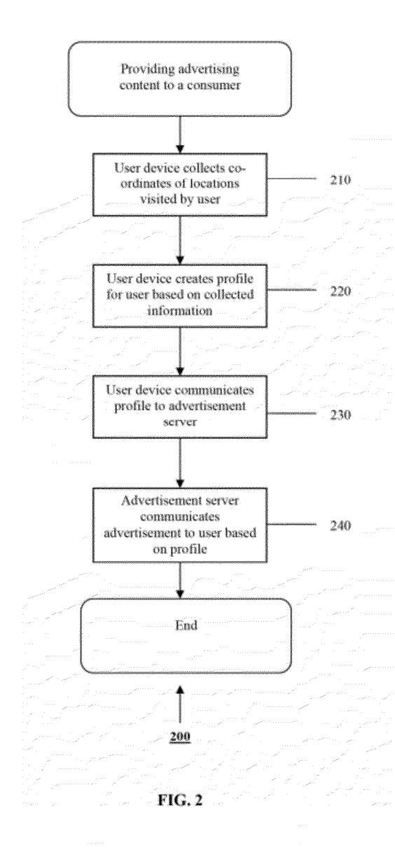

Aspects of embodiments consistent with the invention will now be described with generally with reference to FIG. 2 which is, in one respect, a flow diagram of steps/processes performed by technological means for providing advertising content to a consumer. In another respect, FIG. 2 can be considered to depict means 200 for providing advertising content to a consumer, the means 200 itself comprising the variously illustrated means for performing the described functions.

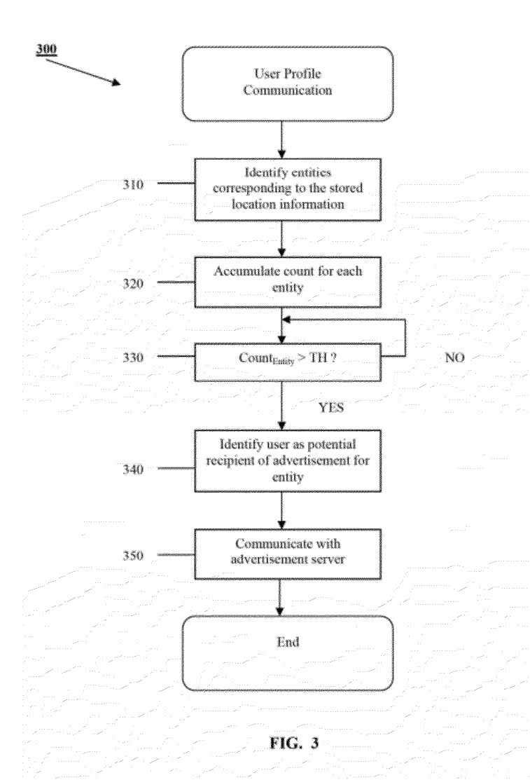

A user device (such as device 120 of FIG. 1) collects location information at 210. The collected information may be used to create preferences (or a profile) for the user (or consumer) of the device at 220. Additional details pertaining to creating the preferences are described further below with reference to FIG. 3. The profile may be communicated to an advertisement server (not illustrated in FIG. 2) at 230. Based on the user profile, the advertisement server may communicate advertising information to the user/consumer at 240.

The user profile may be created according to process 300 illustrated in FIG. 3. Location information may be used to identify entities associated with the stored location information at 310. An exemplary (not actual) location information of 23° 5′ 24″ N (Lat.), 78° 32′ 56″ (Long.), may correspond to “ABC Auto Dealer” or to an auto dealer selling Toyota® automobiles for example. The user device may have access to a database that provides the association between a co-ordinate and a corresponding entity (business establishment). This identification process may be repeated for each location co-ordinate stored in the user device. As described above, in some embodiments, the detection signal may itself identify the entity to the user device. The user device may accumulate the number of visits made by the consumer to a particular entity at 320.

The significance of this step may be described as follows: If a consumer were to visit an automotive dealership several times within a pre-determined (or, pre-specified) time period, it may be an indication of the consumer's interest in buying a car for example. Similarly, if a consumer visits an electronic store several times, it may indicate that the consumer is evaluating electronic equipment. If a consumer were to visit a fast food franchise location several times, it may be an indication that the consumer prefers a particular franchise brand or that the consumer frequently dines at fast food restaurants. In order to conclude that a consumer is looking for an electronic item for example, a pre-determined threshold may be established such that if the accumulated count for a consumer's visit to an electronic store exceeds the threshold, a conclusion may be drawn as to the consumer's interest in purchasing an electronic item. In some embodiments, such accumulation may not be included or needed; that is, the threshold value maybe a single visit to trigger an advertisement.

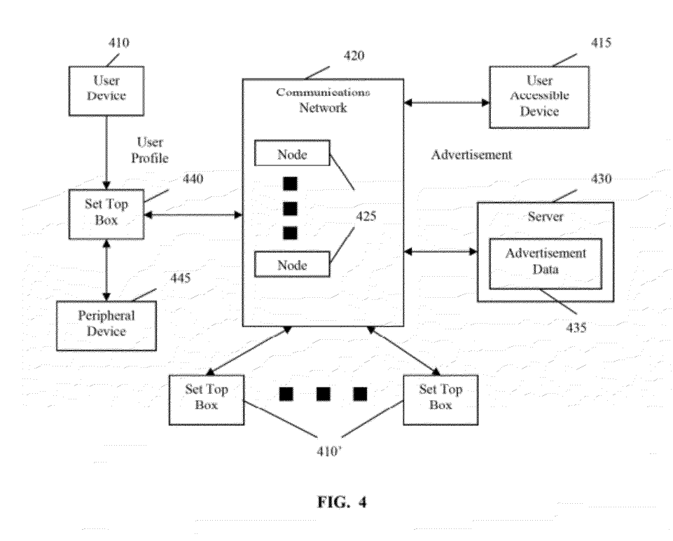

The accumulated count may be compared to the pre-specified threshold at 330. If the count exceeds the threshold, the user may be identified as one that should receive advertising information for the particular entity (having the count exceeding the threshold) at 340. The creation of a user profile or determination of user preferences may comprise the identification of the user as a potential recipient of the advertisement. The profile or preferences may be transmitted to an advertisement server at 340. The process of transmitting the user preferences/profile and receiving advertisements is described further below (with reference to FIG. 4).

The user device may be pre-programmed to create or update user profiles either at pre-determined frequency or at the occurrence of a pre-determined event. A pre-determined event may be the user device receiving an instruction from an electronic device at the user's home such as a cable set-top box for example.

A system for facilitating exemplary embodiments may be illustrated with reference to FIG. 4. A user device 410 may include user profile or preferences as described above. The user profile may be communicated by user device 410 to a server 430 via set-top box 440 and a communication network 420. Server 430 may include advertisement data 435 related to a plurality of products and services. Server 430 may be viewed as being connected to a cable backend. Set-top boxes are known and used in cable television systems for example. These systems provide television programming in homes, places of business, hotels, etc.

The set-top box 440 may be in bi-directional communication with the server 430 via communications network 420. The communication link between set-top box 440 and network 420 as well as that of network 420 and server 430 may be a wired connection. Communication network 420 may include a number of nodes 425 and can be coupled to any number of other set-top boxes 410′ as is known in the art.

The server 430 may receive the user profile and select appropriate advertisements for presentation to the user of user device 410. Server 430 may present the advertisements via the communication network 420 and set-top box 440 to a peripheral device 445. Peripheral device 445 may be a television for example. The destination of the advertisement may be determined by detecting an identity of the (originating) set-top box that conveyed the user profile to the server from the user device.

In some embodiments, the advertisement information may be presented to another user accessible device 415 that is connected to server 430 via the communications network. The communication between server 430 and device 415 may be over a wired or a wireless connection. In some embodiment, user accessible device 415 itself may be the user device (i.e. user equipment) 410.

In some embodiments, the user profile may also be communicated from user device 420 to server 430 via a wireless communication link without the intermediate set-top box 440 for example. In this case, the advertisement may be presented to the user on user device 410. In other embodiments, user device 410 may submit user preferences or profiles via a short range communication link to a computing device connected to the server via a network. The short range communication link may be Bluetooth for example. The computing device may be a personal or a laptop computer for example. The network in this case may be the Internet for example. If the user profiles are submitted to a computing device, the advertisement content may be directed to the IP address of the computer from which the profile is submitted.

In some embodiments, the process of determining user profiles may also include identifying categories based on the various entities visited by the user. A user may visit multiple brand auto dealerships within a predetermined period of time including multiple visits to at least one brand dealership for example. The user can (i) identify how many times the user has visited a particular brand auto dealership within a pre-specified time period; and (ii) identify how many times the user visited auto dealerships within the pre-specified time period. A threshold value for the accumulated count of the categories may also be monitored in some embodiments.

The frequency at which a user device conveys user profiles may be determined by the user. The cable set-top box may poll the user device when the user device is within a vicinity of the set-top box. The user can choose to not submit profiles or even to create profiles. The user can choose to not submit profiles for a period of time or during certain times of the day, of the week, of the month, etc. The user can choose what information may be submitted regarding the user. For example, the user telephone number or the user name may not be submitted. User anonymity may be preserved in this manner.

In some embodiments, the user profile may include other information in addition to co-ordinates of locations visited by the user. This may include demographic information such as gender, age, income, family size, hobbies, spending habits including purchases, web browsing and other activities of the user. In addition to the set-top boxes identified above, point of sale terminals (POS) may detect user devices within their vicinity and prompt the device to submit the user profile. The user device can then submit the general demographic information about the user such as that enumerated above without providing specific identifying information about the user of the user equipment. The POS terminal can present coupons, etc. which may be transmitted to the user device.

Other type of devices that can detect the user terminal and request demographic information in order to provide advertising may include televisions, billboards, etc. The user device may implement known discovery protocols such as Bonjour or DLNA.

The ability to withhold personal information is relevant in situations where a user wishes to have control over dissemination of specific information about him or her.

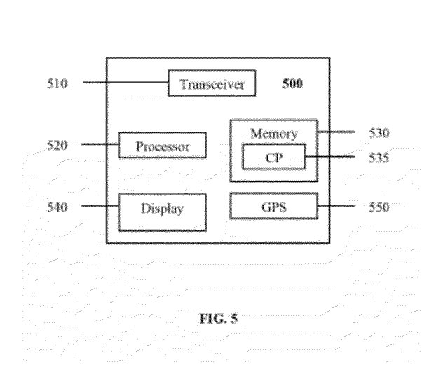

Methods as described according to exemplary embodiments may utilize a user device or user equipment such as user equipment (UE) 500 illustrated in FIG. 5. User device 500 may include may include, inter glia, transceiver 510, processor 520, computer readable medium 530 in the form of a memory, display 540 and a location sensing mechanism 550.

In one embodiment, in order for the processor 520 to be able to perform the steps illustrated in FIG. 2, the memory comprises a computer program (CP) 535 with computer program modules which when run by the processor 520 causes the mobile communication device to perform all or some of the steps illustrated in FIG. 2. The memory may for example be a flash memory, a RAM (Random-access memory) ROM (Read-Only Memory) or an EEPROM (Electrically Erasable Programmable ROM), and the computer program modules described above could in alternative embodiments be distributed on additional memories (not shown) in the user equipment 500. The processor may not only be a single CPU (Central processing unit), but could comprise two or more processing units in user equipment 500. For example, the processor may include general purpose microprocessors, instruction set processors and/or related chips sets and/or special purpose microprocessors such as ASICs (Application Specific Integrated Circuit). The processor may also comprise board memory for caching purposes.

Various embodiments consistent with the invention provide one or more advantages over conventional systems. Allowing television advertisements to be informed by a consumer's actual needs and interests allows advertisers to advertise products more efficiently (i.e., there is no need to waste money trying to sell a car to a consumer who is not in the market for a car) and also allows consumers to be aware of their needs as they arise.

Consumers may also derive a benefit by retaining a control over dissemination of their personal information while still having the ability to provide general demographic information in order to receive specific advertisement that is of interest to the consumers.

Television operators benefit in that their place in an increasingly connected world is made more secure and their advertising revenue remains relevant.

Advertisers can also benefit by being provided a way for those viewers who are truly interested in the advertiser's product to view relevant advertisement. Viewers can save money by remembering sales more easily and are relieved of having to divide their attention between the television and non-television note taking devices (e.g., pen and paper, smart phone, etc).

The invention has been described with reference to particular embodiments. However, it will be readily apparent to those skilled in the art that it is possible to embody the invention in specific forms other than those of the embodiment described above. The described embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A user equipment (UE) comprising:
a location sensing mechanism;
a memory for storing location co-ordinates of a plurality of locations visited by a user of the user equipment;
a processor for determining preferences corresponding to the user based on the stored co-ordinates; and
a transceiver for communicating the preferences.

2. The user equipment of claim 1, further comprising:
a display for presenting advertisements received by the transceiver in response to the communicated preferences.

3. The user equipment of claim 1, wherein the processor further:
identifies entities corresponding to the stored co-ordinates, the entities being product or service providers;
accumulates a count for each entity visited by the user;
identifies the user as a candidate for receiving advertisements corresponding to an entity if the count for the entity exceeds a pre-determine threshold.

4. The user equipment of claim 1, wherein the processor further:
identifies entities corresponding to the stored locations, the entities being product or service providers;
associates the entities to categories wherein the entities within a category are competing providers;
accumulates a count for each category visited by a user of the user equipment;
identifies the user as a candidate for receiving advertisements corresponding to a category if the count for the category exceeds a pre-determine threshold.

5. An advertisement presentation method comprising:
storing location co-ordinates of a plurality of locations visited by a user of a user equipment;
determining preferences corresponding to the user based on the stored co-ordinates;
communicating the preferences to an advertisement control device; and
presenting advertisements received from the device to the user based on the communicated preferences.

6. The method of claim 5, wherein the co-ordinates are stored if a signal is received by the user equipment at the plurality of locations.

7. The method of claim 5, wherein determining the preferences comprises:
identifying entities corresponding to the stored co-ordinates, the entities being product or service providers;
accumulating a count for each entity visited by the user; and
identifying the user as a candidate for receiving advertisements corresponding to an entity if the count for the entity exceeds a pre-determine threshold.

8. The method of claim 5, further comprising:
identifying entities corresponding to the stored co-ordinates, the entities being product or service providers;
associating the entities to categories wherein the entities within a category are competing providers;
accumulating a count for each category visited by the user; and
identifying the user as a candidate for receiving advertisements corresponding to a category if the count for the category exceeds a pre-determine threshold.

9. The method of claim 5, further comprising:
determining the preferences at pre-determined intervals.

10. The method of claim 5, further comprising:
determining the preferences by the user equipment.

11. The method of claim 5, further comprising:
communicating the preferences at pre-determined intervals.

12. The method of claim 5, further comprising:
communicating the preferences in response to a request from the control device.

13. The method of claim 12, wherein the control device is a cable set-top box.

14. The method of claim 12, wherein the control device is a cable backend.

15. The method of claim 14, wherein the control device is a server connected to the cable backend.

16. The method of claim 5, further comprising:
communicating the preferences via a wireless interface.

17. The method of claim 5, further comprising:
communicating the preferences via a cellular interface.

18. The method of claim 5, further comprising:
presenting the advertisements on the user equipment.

20. The method of claim 5, further comprising:
presenting the advertisements on a television.

21. The method of claim 5, further comprising:
selectively controlling the communication of the preferences.

22. The method of claim 5, wherein the preferences exclude personal identification information of the user.

23. A computer program comprising computer readable program modules which when run on a user equipment causes the user equipment to:
store location co-ordinates of a plurality of locations visited by a user of a user equipment;
determine preferences corresponding to the user based on the stored co-ordinates;
communicate the preferences to an advertisement control device; and
present advertisements received from the device to the user based on the communicated preferences.
